(19) United States
(12) Patent Application Publication
(10) Pub. No.: US 2008/0014813 A1
(43) Pub. Date: Jan. 17, 2008

(54) Fiber mat with formaldehyde-free binder

(75) Inventors: Linlin Xing, Wayne, NJ (US); Yaron Steinhauer, Valley Cottage, NY (US); William Bittle, York, SC (US)

Correspondence Address: GAF MATERIALS CORPORATION;Attn: William J. Davis, Esq., Legal Department, Building No. 8-2, 1361 Alps Road, Wayne, NJ, 07470, US

(73) Assignee: BUILDING MATERIALS INVESTMENT CORPORATION

(21) Appl. No.: 11/485,149

(22) Filed: Jul. 12, 2006

(51) Int. Cl. B32B 5/02

(52) U.S. Cl. 442/59

(57) ABSTRACT

A formaldehyde-free glass fiber mat for use in a building material of improved mat tensile and shingle tensile strength is disclosed. The fiber mat comprises a plurality of fibers; and a resinous fiber binder which is a styrene-acrylate dispersion modified with polycarboxylic acid, and a polyol cross-linking agent.

### BACKGROUND OF THE INVENTION

1. Field of the Invention

This invention relate to a fiber mat and more particularly, to a glass fiber mat including a formaldehyde-free binder.

2. Description of the Prior Art

High strength fiber mats have become increasingly popular in the building materials industry. Most commonly used in roofing shingles, fiber mats have numerous other material applications, including use in roofing, siding and floor underlayment; insulation facers; floor and ceiling tile; and vehicle parts.

Various fiber mats and methods of making same have been previously described utilizing formaldehyde-free binders. For example, U.S. Pat. Nos. 5,932,665, 6,114,464, 6,299,936, 6,136,916, 6,348,530 and EP 1655400A1 describe glass fiber mats made by a wet-laid process.

Typically, in wet processed glass fiber mats, the binder is applied in a liquid form and dispersed onto the glass fibers by a curtain type applicator. Conventional wet processes strive to produce a uniform coating of binder on the glass fibers. After the binder and glass fibers have been dried and cured, the glass fiber mat is then cut as desired.

Inadequate shingle tensile strength also can reduce the ability of the finished roofing product to resist stresses during service on the roof. Because building materials, generally, and roofing shingles, in particular, are often subjected to a variety of weather conditions, the fiber mats should also maintain their strength characteristics under a wide range of conditions.

Federal regulations (International Agency for Research on Cancer) reclassified formaldehyde as carcinogenic to humans. Hence, there is an effort in the industry to avoid formaldehyde-containing materials in binders.

### SUMMARY OF THE INVENTION

Responsive to the foregoing challenges, Applicants have developed an innovative fiber mat for use in a building material, the mat comprising:

55% to 99.5% w/w, and preferably 72% w/w to 98% of a plurality of fibers;

0.05% to 45% w/w, and preferably 2% to 28% w/w of a resinous fiber binder which coats the fibers, comprising a styrene-acrylate dispersion modified with polycarboxylic acid and a polyol as the cross-linking agent.

Applicants have further developed an innovative fiber mat for use in a building material, comprising:

55% to 99.5% w/w, and preferably 72% w/w to 98% of a plurality of glass fibers;

0.05% to 45%, and preferably 2% to 28% w/w of a formaldehyde-free resinous fiber binder which coats the glass fibers; comprising a styrene-acrylate dispersion modified with polycarboxylic acid and a polyol as the cross-linking agent.

Applicants have developed an innovative process of making a fiber mat for use in a building material, the process comprising the steps of: (a) forming an aqueous fiber slurry; (b) removing water from the fiber slurry to form a wet fiber mat; (c) saturating the wet fiber mat with an aqueous solution of a fiber binder; comprising a styrene-acrylate dispersion modified with polycarboxylic acid and a polyol as the cross-linking agent, and (d) drying and curing the wet fiber mat to form a fiber mat product.

It is to be understood that both the foregoing general description and the following detailed description are exemplary and explanatory only, and are not restrictive of the invention as claimed.

### DETAILED DESCRIPTION OF THE INVENTION

The fiber mat of the present invention may comprise a plurality of fibers coated or impregnated with a fixative composition. The fixative composition may comprise a formaldehyde-free resinous fiber binder comprising between about 0.05 % wt. % and about 45 wt. % of a styrene-acrylate dispersion modified with polycarboxylic acid, and a polyol as the cross-linking agent, based on the fiber binder weight.

In all embodiments of the present invention the binder is ACRODUR® DS-3558 resin (BASF) which is a styrene-acrylate dispersion modified with polycarboxylic acid and a polyol as the cross-linking agent. The individual mats were soaked in the binder solution under ambient conditions after which excess solution was removed under vacuum to provide binder wet mats containing about 60-62% w/w fibers, 8-10% w/w binder, and about 30% w/w water.

In one embodiment of the present invention, the fibers comprise glass fibers. The glass fibers may comprise individual fiber filaments having an average length in the range of, but not limited to, from about ¼ inch to about 3 inches, and an average diameter in the range of, but not limited to, from about 5 to about 50 micrometers (μm). It is contemplated, however, that the glass fibers may be in another form, such as, for example, a continuous strand or strands. In an alternative embodiment of the present invention, the fibers may comprise other fibers, including, but not limited to, wood, polyethylene, polyester, nylon, polyacrylonitrile, and/or a mixture of glass and one or more other fibers. In one embodiment, the fiber mat may further comprise a small amount of filler, e.g. less than about 0.5%, based on the fiber weight. A fiber mixture may be optional for construction material application, such as, for example, roofing and siding, because excessive amounts of filler may reduce porosity and vapor ventability of the fiber mat.

In the finished cured mat product, the fiber content may be in the range of from about 55 wt. % to about 99.5 wt. %. In one embodiment of the present invention, the fiber content is more particularly in the range of from about 72 wt. % and about 98 wt. %. The binder content may be in the range of from about 0.05 wt. % to about 45 wt. %. In one embodiment of the present invention, the binder content is more particularly in the range of from about 2 wt. % to about 28 wt. %.

In one embodiment of the present invention, the fibers may be formed into a mat with the aid of a dispersing agent. The fiber dispersing agent may comprise, for example, tertiary amine oxides (e.g. N-hexadecyl-N,N-dimethyl amine oxide), bis(2-hydroxyethyl) tallow amine oxide, dimethyl hydrogenated tallow amine oxide, dimethylstearyl amine oxide and the like, and/or mixtures thereof. As will be apparent to those of ordinary skill in the art, other known dispersing agents may be used without departing from the scope and spirit of the present invention. The dispersing agent may comprise a concentration in the range of from about 10 ppm to about 8,000 ppm, based on the amount of fiber. The dispersing agent may further comprise a concentration in the range of from about 200 ppm to about 1,000 ppm, based on the amount of fiber.

In one embodiment, the fibers may be formed into a mat with the aid of one or more viscosity modifiers. The viscosity modifier may be adapted to increase the viscosity of the composition such that the settling time of the fibers is reduced and the fibers may be adequately dispersed. The viscosity modifier may include, but is not limited to, hydroxyl ethyl cellulose (HEC), polyacrylamide (PAA), and the like. As will be apparent to those of ordinary skill in the art, other viscosity modifiers may be used without departing from the scope and spirit of the present invention.

The process of making a fiber mat in accordance with one embodiment of the present invention will now be described. The process will be described with particular reference to a wet-laid process. It is contemplated, however, that other processes known in the art, such as, for example, a dry-laid process, may be used without departing from the scope and spirit of the present invention. Furthermore, the process is described using chopped bundles of glass fibers. As discussed above, however, other types of fiber content are considered well within the scope of the present invention.

The process of forming glass fiber mats according to one embodiment of the present invention comprises adding chopped bundles of glass fibers of suitable length and diameter to an aqueous medium to form an aqueous fiber slurry. As discussed above, the aqueous medium may include a suitable dispersing agent. A viscosity modifier or other process aid may also be added to the water/dispersing agent medium. From about 0.05 to about 0.5 wt. % viscosity modifier in white water may be suitably added to the dispersant to form the slurry.

The glass fibers may be sized or unsized, and may be wet or dry, as long as they are capable of being suitably dispersed in the water/dispersing agent medium. The fiber slurry, containing from about 0.03 wt. % to about 8 wt. % solids, is then agitated to form a workable dispersion at a suitable and uniform consistency. The fiber slurry may be additionally diluted with water to a lower fiber concentration to between about 0.02 wt. % and about 0.08 wt. %. In one embodiment, the fiber concentration may be more particularly diluted to about 0.04 wt. % fiber. The fiber slurry is then passed to a mat-forming machine such as a wire screen or fabric for drainage of excess water. The excess water may be removed with the assistance of vacuum.

The fibers of the slurry are deposited on the wire screen and drained to form a fiber mat. The fiber mat may then be saturated with an aqueous solution of binder. The aqueous binder solution may comprise, for example, from about 10 wt. % to about 40 wt. % solids. The fiber mat may be soaked for a period of time sufficient to provide the desired fixative for the fibers. Excess aqueous binder solution may then be removed, preferably under vacuum.

After treatment with binder, the mat is then dried and the fixative composition may be cured in an oven at an elevated temperature. A temperature in the range of about 160° C. to about 400° C., for at least about 2 to about 10 seconds, may be used for curing. In one embodiment, a cure temperature in the range of about 225° C. to about 350° C. may be used. It is contemplated that in an alternative embodiment of the present invention, catalytic curing may be provided with an acid catalyst, such as, for example, ammonium chloride, p-toluene sulfonic acid, or any other suitable catalyst.

The fiber binder used in various embodiments of the present invention may provide several advantages over current binder compositions. For example, the tensile strength of the shingle may be increased. In addition, the tensile strength of the shingle may be increased at lower temperatures to minimize cracking and failure. Other advantages will be apparent to one of ordinary skill in the art from the above detailed description and/or from the practice of the invention.

Having generally described various embodiments of the present invention, reference is now made to the following examples which illustrate embodiments of the present invention and comparisons to a control sample. The following examples serve to illustrate, but are not to be construed as limiting to, the scope of the invention as set forth in the appended claims.

### Preparation of Glass Mat

Part A. In a 20 liter vessel at room temperature, under constant agitation, 6.19 g of chopped bundles of glass fibers, having an average 20-40 mm length and 12-20 micron diameter, were dispersed in 12 liters of water containing 800 ppm of N-hexadecyl-N,N-dimethylamine oxide to produce a uniform aqueous slurry of 0.04 wt. % fibers. The fiber slurry was then passed onto a wire mesh support with dewatering fabric, and a vacuum was applied to remove excess water and to obtain a wet mat containing about 60% fibers.

Part B. Aqueous samples of 10 wt. % solids containing ACRODUR® DS-3558 resin binder (styrene-acrylate dispersion modified with polycarboxylic acid, and a polyol as the cross-linking agent) supplied by BASF was prepared and applied to individual samples of wet glass mats prepared by the procedure in Part A. The individual wet mats were soaked in the binder under ambient conditions after which excess solution was removed under vacuum to provide binder wet mats containing 61.6 wt. % glass fibers, 8.4 wt. % binder and 3 wt. % water.

Part C. For comparison purposes, Control samples were prepared as described in Parts A and B except that a urea-formaldehyde resin UF binder, GP 2997 supplied by Georgia Pacific Corp. or Hexion FG607A supplied by Hexion Specialty Chemcials, was used.

Part D. The mat samples made according to Parts A and B were dried and cured for 5 seconds at 225° C. to 300° C. to obtain dry glass mats weighing about 92 g/m² and having a Loss on Ignition (LOI) of about 12%.

Part E. The mat samples made according to Part C were dried and cured for 9 seconds at 300° C. to obtain dry glass mats weighing about 92 g/m² and having a Loss on Ignition (LOI) of about 19%. The glass mats were tested for mat tensile strength.

Part F. Each of the above cured mat samples were passed to a two-roller coating machine where a 30 mil layer of 32 wt. % asphalt and 68 wt. % limestone filler at 420° F. was applied to each side of the mats. After cooling, the thus-filled asphalt coated mats were tested for shingle tensile properties. The results of these tests are given in the Tables below.

TABLE 1
Binder Compositions

| Ingredient | Control | Invention Example |
|---|---|---|
| Binder | GP2997 or | ACRODUR ® DS-3558 |
| | Hexion FG607A | |
| Binder Chemistry | Urea- | Styrene-acrylate |
| | Formaldehyde | dispersion modified |
| | Resin | with polycarboxylic |
| | | acid and a polyol as |
| | | the crosslinking agent |

TABLE 2
Mat Properties

| | | Invention | % Change over |
|---|---|---|---|
| Property | Control | Example | Control |
| Mat Basis | 92 | 92 | — |
| Weight (gms) | | | |
| Mat LOI % | 19 | 12 | — |
| Curing | 300 C./8 sec | 225 C./5 sec | — |
| Mat Tensile | 175 | 313 | +79 |
| (N/50 mm) | | | |
| Mat Porosity | 249 | 269 | +8 |
| (m³/m²/min) | | | |
| Mat Caliper | 1.08 | 0.96 | −11 |
| (mm) | | | |
| Shingle Tensile | 1155 | 1368 | +18 |
| (psi) | | | |

The results show a significant increase in mat tensile and shingle tensile strength for the Invention Example over the Control.

It will be apparent to those skilled in the art that various other modifications and variations can be made in the construction, configuration, and/or operation of the present invention without departing from the scope or spirit of the invention. Embodiments of the fiber mat may be used in the building material including but not limited to, shingles, underlayment, insulation facers, floor and ceiling tile, vehicle parts, and/or any other suitable building material. Thus, it is intended that the present invention cover all such modifications and variations of the invention, provided they come within the scope of the appended claims and their equivalents.

What is claimed is:

1. A formaldehyde-free fiber mat for use in a building material, said fiber mat comprising:
55% w/w to 99.5% w/w of a plurality of fibers; and
0.05% w/w to 45% w/w of a resinous fiber binder which coats the fibers; characterized by comprising a styrene-acrylate dispersion modified with polycarboxylic acid, and a polyol as the cross-linking agent.

2. The formaldehyde-free fiber mat of claim 1 comprising:
72% w/w to 98% w/w of a plurality of fibers; and
2% w/w to 28% w/w of said resinous fiber binder.

3. A formaldehyde-free fiber mat of claim 1 wherein said fibers are glass fibers.

4. The glass fiber mat of claim 3 wherein said glass fibers comprise a plurality of glass filaments having an average length of from about 0.25 to about 3 inches and a diameter of from about 5 to 50 micrometers.

5. The glass fiber mat of claim 4 wherein the concentration of said filaments is between about 55 and about 98 wt. %.

6. A process of making a formaldehyde-free glass fiber mat for use in a building material, said process comprising the steps of:
(a) forming an aqueous glass fiber slurry;
(b) removing water from the fiber slurry to form a wet fiber mat;
(c) saturating the wet fiber mat with an aqueous solution of the fiber binder of claim 1 and
(d) drying and curing the wet fiber mat to form a fiber mat product.

7. The process of claim 6 wherein the aqueous fiber slurry further comprises a fiber dispersing agent.
